(19) United States
(12) Patent Application Publication
(10) Pub. No.: US 2006/0072170 A1
(43) Pub. Date: Apr. 6, 2006

(54) Color chart, chart data creating apparatus, and chart data creating program storage medium

(75) Inventors: Shigeki Kawakami, Kanagawa (JP); Eiji Teraue, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/237,748

(22) Filed: Sep. 29, 2005

(30) Foreign Application Priority Data
Sep. 30, 2004 (JP) 2004-288154

(51) Int. Cl. H04N 1/46

(52) U.S. Cl. 358/504

(57) ABSTRACT

A color chart comprises: at least one reference patch formed with at least one color material, the reference patch having a predetermined reference color; a first adjacent patch adjacent to the reference patch; and a second adjacent patch adjacent to the reference patch. The first adjacent patch is formed in such a manner that the reference color is reproduced with a plurality of colors of color materials including a color material different from the color material of the reference patch. The second adjacent patch is formed with same color material as the color materials of the first adjacent patch and use level of color material of a balance that is different from a balance of use level of the color material of the first adjacent patch.

### BACKGROUND OF THE INVENTION

1. Field of the Invention

The present invention relates to a color chart, a chart data creating apparatus for creating chart data representative of the color chart, and a chart data creating program storage medium storing a chart data program which causes a computer to operate as the chart data creating apparatus when the chart data program is executed in the computer.

2. Description of the Related Art

In a color image forming apparatus, such as a color printing machine and a color printer, which represents colors of an image using a plurality of colors of color materials, it is desired to always constantly maintain a balance of an amount of use of the color material associated with a certain color to some extent. However, the image forming characteristic of the color image forming apparatus will change with elapse, and as a result, the balance of an amount of use of the color material will change. This will bring about such an inconvenience that colors of an image cannot be expressed exactly. In order to avoid such the inconvenience, there is performed a so-called calibration work that the balance of an amount of use of the color material is established to meet the reference balance, which is determined every image forming apparatus. The calibration work is applied to an image forming apparatus every a predetermined regular interval so that the balance of an amount of use of the color material is maintained. On the other hand, however, the calibration work is a troublesome work and brings about a problem that it imposes a burden on a user. In order to suppress the execution of the calibration work to a minimum, there is proposed a technology that an image forming apparatus of interest in calibration outputs an image for the calibration work, so that the outputted image is measured in color, and when it is decided in accordance with a result of the colorimetry that the image forming apparatus does not express colors exactly, the calibration work is applied (cf. for example, Japanese Patent Application Laid Open Gazette TokuKai Hei. 10-322564 (pages 3-11, FIG. 7).

However, according to the technology disclosed in Japanese Patent Application Laid Open Gazette TokuKai Hei. 10-322564, troublesome is a series of works such as the output of an image for the calibration work, the colorimetry for the image, and the analysis of the result of the colorimetry. This also brings about a problem that it imposes a burden on a user.

### SUMMARY OF THE INVENTION

In view of the foregoing, it is an object of the present invention to provide a color chart capable of simply deciding time of an execution for a calibration work, a chart data creating apparatus for creating chart data representative of the color chart, and a chart data creating program storage medium storing a chart data program which causes a computer to operate as the chart data creating apparatus when the chart data program is executed in the computer.

To achieve the above-mentioned object, the present invention provides a color chart comprising:

at least one reference patch formed with at least one color material, the reference patch having a predetermined reference color;

a first adjacent patch adjacent to the reference patch, the first adjacent patch being formed in such a manner that the reference color is reproduced with a plurality of colors of color materials including a color material different from the color material of the reference patch; and

a second adjacent patch adjacent to the reference patch, the second adjacent patch being formed with same color material as the color materials of the first adjacent patch and use level of color material of a balance that is different from a balance of use level of the color material of the first adjacent patch.

According to the color chart of the present invention, the color of the first adjacent patch essentially becomes the reference color that is the same as the color of the reference patch. Assuming that the image forming apparatus, which outputs the color chart, deviates in a balance of use level of the color material from the reference balance set up at the time of the calibration, so that the color of the image cannot be exactly expressed, this would bring about a difference in color between the first adjacent patch and the reference patch. Further, in the event that the deviation of the balance is large, the color of the second adjacent patch, which ought to be essentially different from the color of the reference patch, would be a color closer to the color of the reference patch rather than the color of the first adjacent patch. Further, according to the color chart of the present invention, a user can visually easily confirm an approximation of colors between the reference patch and the first adjacent patch, and an approximation of colors between the reference patch and the second adjacent patch, since the patches are adjacent to one another. In this manner, according to the color chart of the present invention, it is possible for a user to easily judge through the visual confirmation whether the image forming apparatus needs the calibration work. In other words, according to the color chart of the present invention, it is possible for a user to easily judge the time for the execution of the calibration work.

In the event that the reference patch is provided on, for example, each of both the first adjacent patch and the second adjacent patch, there is no need that the colors of the respective reference patches are strictly the same color as one another, and it is acceptable that between the colors of the respective reference patches there is a difference in color including errors in an image forming apparatus for outputting the color chart of the present invention, and any one is acceptable, which is substantially the reference color, as the color of the respective reference patch. What is the substantially the reference color is a color including an error that is smaller than a difference between the color of the first adjacent patch and the color of the second adjacent patch, and does not disturb an judgement of the execution time of the calibration work.

An attachment of the color chart of the present invention, which is outputted from a certain image forming apparatus, to an image outputted from the image forming apparatus makes it possible for a person who received the image to judge whether the image is of an output from the image forming apparatus in a proper state through a visual confirmation of the color chart of the present invention appended to the image. In other words, according to the color chart of the present invention, for example, it is possible to add information indicative of the state of an image forming apparatus to the image outputted from the image forming apparatus.

In the color chart according to the present invention as mentioned above, it is preferable that the second adjacent patch is different in use level of one color material of the color materials from the use level of the color material of the first adjacent patch.

Generally, in an image forming apparatus, in the event that a balance of use of level of the color material is deviated from the reference balance set up at the time of the calibration, it is known through an experience that the use level of the color material of any one of the plurality of colors is often deviated. According to the color chart of the preferable aspect as mentioned above, a user can readily know the color material, which is deviated in use level, through visual comparison of the color of the first adjacent patch and the color of the reference patch, and the color of the second adjacent patch and the color of the reference patch, so that the user can perform the more suitable calibration work.

In the color chart according to the present invention as mentioned above, it is acceptable that the color chart has a gradation bar serving both as the first adjacent patch and the second adjacent patch.

According to this type of color chart, the gradation bar is adjacent to the reference patch. Thus, the user can see a deviation of the balance of the use level of the color material in the image forming apparatus that outputs the color chart, through visual comparison of the colors of the respective parts of the gradation bar with the color of the reference patch.

In the color chart according to the present invention as mentioned above, it is acceptable that the color chart has, as the reference patch, a plurality of reference patches corresponding to the first adjacent patch and the second adjacent patch on a one-to-one basis.

In the color chart according to the present invention as mentioned above, it is acceptable that the color chart has, as the reference patch, only one reference patch adjacent to both the first adjacent patch and the second adjacent patch.

According to those aspects as mentioned above, it is possible to implement the reference patch capable of readily being compared in colors with the first adjacent patch and the second adjacent patch.

To achieve the above-mentioned object, the present invention provides a chart data creating apparatus comprising:

a balance data obtaining section that obtains first balance data representative of a balance of use level of a color material where an image forming apparatus for outputting an image represented by image data with a plurality of color materials is used to reproduce a predetermined reference color, which is represented with at least one color material by the image forming apparatus, with a plurality of colors of color materials including a color material different from said color material;

a balance data creating section that creates a second balance data through alteration of the balance of the use level represented by the first balance data; and

a chart data creating section that creates chart data representative of a color chart in accordance with the first balance data and the second balance data, the color chart comprising: at least one reference patch having the reference color; a first adjacent patch adjacent to the reference patch, the first adjacent patch being formed in such a manner that the reference color is reproduced with a plurality of colors of color materials including a color material different from the color material of the reference patch; and a second adjacent patch adjacent to the reference patch, the second adjacent patch being formed with same color material as the color materials of the first adjacent patch and use level of color material of a balance that is different from a balance of use level of the color material of the first adjacent patch.

According to the chart data creating apparatus of the present invention as mentioned above, a first data portion representative of the reference patch of the chart data is created in accordance with at least one color material and the use level of the color material, a second data portion representative of the first adjacent patch is created in accordance with the first balance data, and a third data portion representative of the second adjacent patch is created in accordance with the second balance data. Thus, according to the chart data creating apparatus of the present invention as mentioned above, it is possible to create chart data representative of the color chart capable of visually readily judging the execution time of the calibration work of the image forming apparatus of interest of the calibration work.

In the chart data creating apparatus according to the present invention as mentioned above, it is preferable that the chart data creating apparatus further comprises:

an image data obtaining section that obtains image data; and

an image data with chart creating section that creates image data with chart representative of an image with chart in which a color chart represented by the chart data is appended to an image represented by the image data, using the chart data created by the chart data creating section and the image data.

According to the chart data creating apparatus of the preferable aspect as mentioned above, it is possible to create the image data with chart representative of the image with chart in which the color chart indicative of the state of an image forming apparatus for outputting the image is appended to the image.

To achieve the above-mentioned object, the present invention provides a chart data creating program storage medium storing a chart data creating program which causes a computer to operate as a chart data creating apparatus, when the chart data creating program is incorporated into the computer and is executed, the chart data creating apparatus comprising:

a balance data obtaining section that obtains first balance data representative of a balance of use level of a color material where an image forming apparatus for outputting an image represented by image data with a plurality of color materials is used to reproduce a predetermined reference color, which is represented with at least one color material by the image forming apparatus, with a plurality of colors of color materials including a color material different from said color material;

a balance data creating section that creates a second balance data through alteration of the balance of the use level represented by the first balance data; and

a chart data creating section that creates chart data representative of a color chart in accordance with the first balance data and the second balance data, the color chart comprising: at least one reference patch having the reference color; a first adjacent patch adjacent to the reference patch, the first adjacent patch being formed in such a manner that the reference color is reproduced with a plurality of colors of color materials including a color material different from the color material of the reference patch; and a second adjacent patch adjacent to the reference patch, the second adjacent patch being formed with same color material as the color materials of the first adjacent patch and use level of color material of a balance that is different from a balance of use level of the color material of the first adjacent patch.

According to the chart data creating program storage medium storing the chart data creating program of the present invention as mentioned above, it is possible to easily implement the chart data creating apparatus for creating the chart data representative of the color chart capable of visually readily judging the execution time of the calibration work of the image forming apparatus of interest of the calibration work.

The chart data creating apparatus and the chart data creating program storage medium, as mentioned above, include all the aspects corresponding to those of the color chart as mentioned above.

### BRIEF DESCRIPTION OF THE DRAWINGS

FIG. 1 is a construction view of a printing-proof system to which an embodiment of a chart data creating apparatus of the present invention is applied.

FIG. 2 is a perspective view of a personal computer 50 shown in FIG. 1.

FIG. 3 is a hardware structural view of the personal computer 50.

FIG. 4 is a conceptual view of a CD-ROM storing a chart data creating program stored in a chart data creating program storage medium according to one embodiment of the present invention.

FIG. 5 is a functional block diagram of a chart data creating apparatus wherein a chart data creating program is installed in the personal computer 50 shown in FIG. 1, and causes the personal computer 50 to operate as an embodiment of a chart data creating apparatus of the present invention.

FIG. 6 is a typical illustration showing a first embodiment of a color chart of the present invention.

FIG. 7 is a typical illustration showing a second embodiment of a color chart of the present invention.

FIG. 8 is a typical illustration showing a third embodiment of a color chart of the present invention.

### DETAILED DESCRIPTION OF PREFERRED EMBODIMENTS

Embodiments of the present invention will be described with reference to the accompanying drawings.

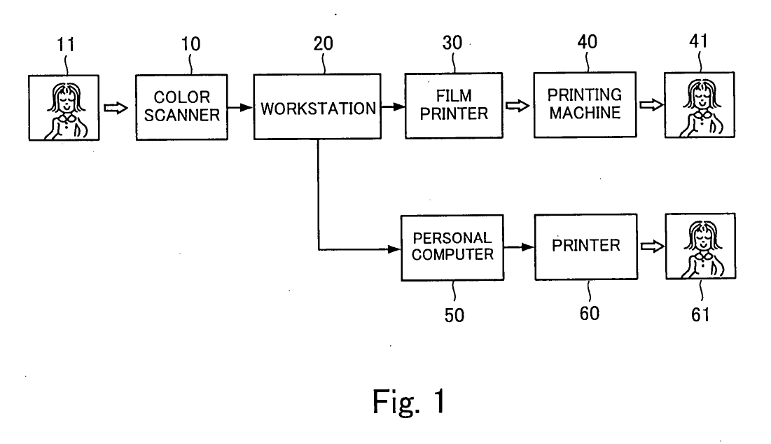

FIG. 1 is a construction view of a printing-proof system to which an embodiment of a chart data creating apparatus of the present invention is applied.

A color scanner 10 reads an original image and creates color separation image data for C(cyan), M(magenta), Y(yellow), K(black) of four colors representative of the read original image. The color separation image data is fed to a workstation 20. In the workstation 20, an operator performs an electronic page make-up in accordance with the entered color separation image data to create printing image data representative of an image for printing.

The printing image data representative of an image for printing is description language data described in a so-called PDL (Page Description Language). In the workstation 20, a so-called RIP (Raster Image Processor) is used to convert the printing image data into dot image data representative of a dot structure of C(cyan), M(magenta), Y(yellow), K(black) of four colors. When the printing is performed, the dot image data is fed to a film printer 30. The film printer 30 creates an original plate of a film for printing consisting of plates for CMYK in accordance with the entered dot image data. A machine plate is created from the original plate of a film for printing. The machine plate thus created is mounted onto a printing machine 40. The machine plate mounted onto the printing machine 40 is applied with ink, and the applied ink is transferred to a sheet for printing, so that a printed image 41 is formed on the sheet.

A work for printing the printed image 41 is such a series of large scale of work that the film printer 30 is used to create a film original plate for printing from the dot image data, a machine plate is created and is mounted onto the printing machine 40, and the machine is applied with inks to perform a printing on a sheet. And this work takes a lot of cost. For this reason, prior to the actual printing work, a proof image 61 is created by a personal computer 50 and a printer 60 to confirm the finish of the printed image 41 beforehand.

To create the proof image 61, image data, which is the same as the image data for CMYK that is the base of the dot image data fed to the workstation 20, is fed from the workstation 20 to the personal computer 50. This image data is converted by the personal computer 50 into dot image data for proof. The dot image data for proof is fed to a printer 60. The printer 60 prints out a proof image on a recording paper in accordance with the dot image data for proof. The proof image thus printed out is a reproduction of an image printed by the printing machine.

According to the above-mentioned printing-proof system in conjunction with FIG. 1, the workstation 20 and the personal computer 50 together operate as an embodiment of a chart data creating apparatus of the present invention. When the workstation 20 and the personal computer 50 operate as an embodiment of a chart data creating apparatus of the present invention, the workstation 20 and the personal computer 50 have the same functional structure as one another. Thus, hereinafter, there will be explained typically the personal computer 50 that operates as an embodiment of a chart data creating apparatus of the present invention.

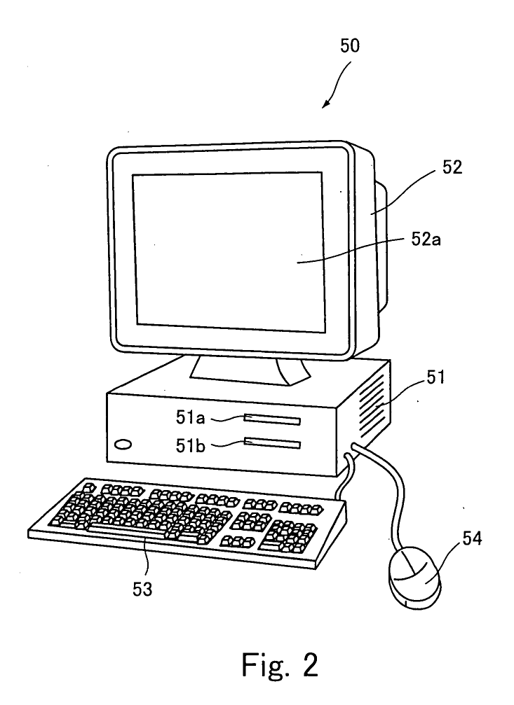

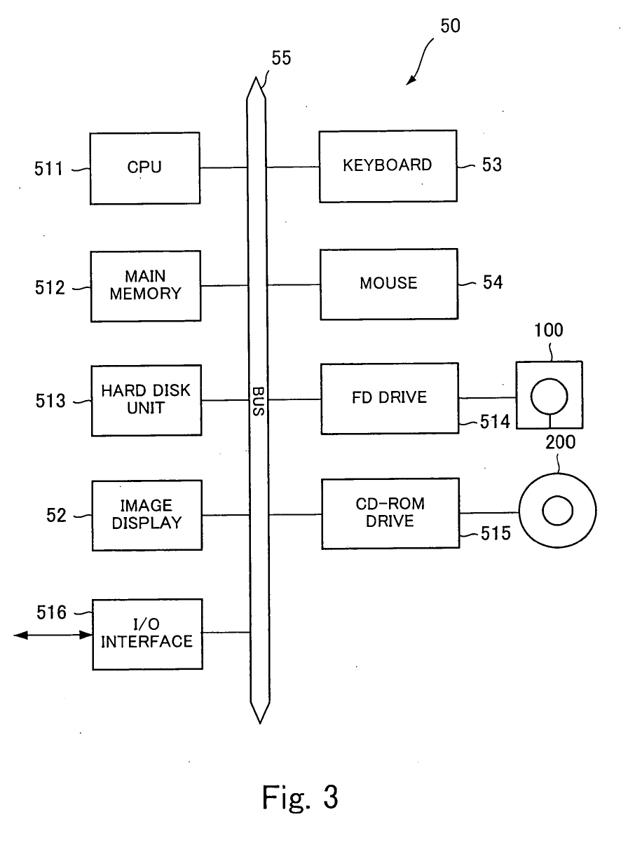

FIG. 2 is a perspective view of the personal computer 50 shown in FIG. 1. FIG. 3 is a hardware structural view of the personal computer 50.

The personal computer 50 comprises, on an external appearance, a main frame unit 51, an image display unit 52 for displaying an image on a display screen 52a in accordance with an instruction from the main frame unit 51, a keyboard 53 for inputting various sorts of information to the main frame unit 51 in accordance with a key operation, and a mouse 54 for inputting an instruction according to, for example, an icon and the like, through designation of an optional position on the display screen 52a, the icon and the like being displayed on the position on the display screen 52a. The main frame unit 51 has a flexible disk mounting slot 51a for mounting a flexible disk (FD), and a CD-ROM mounting slot 51b for mounting a CD-ROM.

The main frame unit 51 comprises, as shown in FIG. 3, a CPU 511 for executing a various types of program, a main memory 512 in which a program stored in a hard disk unit 513 is read out and developed for execution by the CPU 511, the hard disk unit 513 for saving various types of programs and data, a flexible disk drive 514 for accessing a flexible disk 100 mounted thereon, a CD-ROM drive 515 for accessing a CD-ROM 200 mounted thereon, and an I/O interface 516 connected to external apparatuses such as the workstation 20 and the printer 60 of FIG. 1 to perform a communication of various types of data such as image data with the external apparatuses. These various types of elements are connected via a bus 55 to the image display unit 52, the keyboard 53 and the mouse 54.

The CD-ROM 200 stores therein a chart data creating program for causing the personal computer 50 to operate as an embodiment of a chart data creating apparatus of the present invention. The CD-ROM 200 is mounted on the CD-ROM drive 515 so that the chart data creating program, which is stored in the CD-ROM 200, is up-loaded on the personal computer 50 and is stored in the hard disk unit 513. Thus, the personal computer 50 operates as a chart data creating apparatus.

Next, there will be described a chart data creating program, which will be executed in the personal computer 50 in FIG. 1.

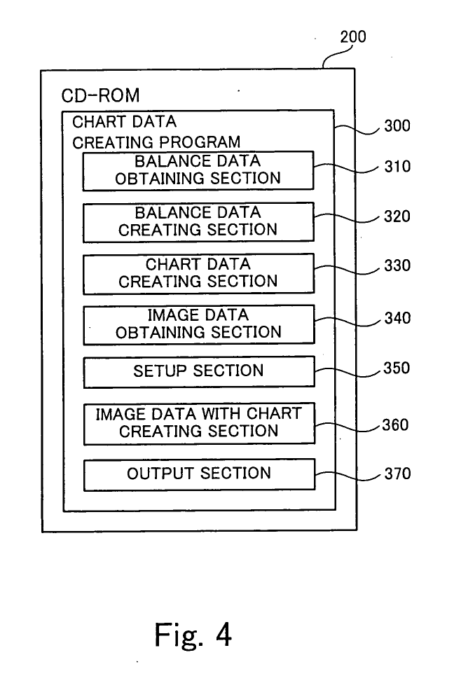

FIG. 4 is a conceptual view of a CD-ROM storing a chart data creating program stored in a chart data creating program storage medium according to one embodiment of the present invention.

A chart data creating program 300 shown in FIG. 4 comprises a balance data obtaining section 310, a balance data creating section 320, a chart data creating section 330, an image data obtaining section 340, a set up section 350, an image data with chart creating section 360, and an output section 370.

The details of the chart data creating program 300 will be described in conjunction with the functions of a chart data creating apparatus according to one embodiment of the present invention.

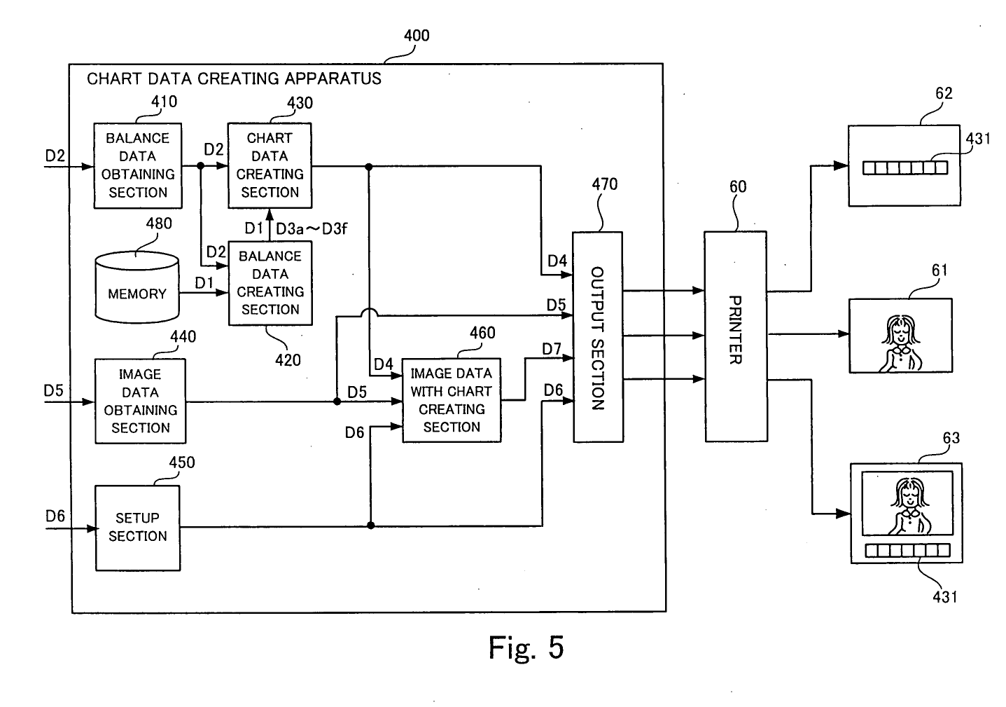

FIG. 5 is a functional block diagram of a chart data creating apparatus wherein a chart data creating program is installed in the personal computer 50 shown in FIG. 1, and causes the personal computer 50 to operate as an embodiment of a chart data creating apparatus of the present invention.

The chart data creating apparatus 400 shown in FIG. 5 comprises a balance data obtaining section 410, a balance data creating section 420, a chart data creating section 430, an image data obtaining section 440, a set up section 450, an image data with chart creating section 460, an output section 470, and a memory 480. The balance data obtaining section 410, the balance data creating section 420, the chart data creating section 430, the image data obtaining section 440, and the image data with chart creating section 460 correspond to the balance data obtaining section 310, the balance data creating section 320, the chart data creating section 330, the image data obtaining section 340, and the image data with chart creating section 360 in the chart data creating program 300, respectively.

When the chart data creating program 300 shown in FIG. 4 is installed in the personal computer 50, the balance data obtaining section 310 in the chart data creating program 300 constitutes the balance data obtaining section 410 shown ion FIG. 5. Likely, the balance data creating section 320 constitutes the balance data creating section 420, the chart data creating section 330 constitutes the chart data creating section 430, the image data obtaining section 340 constitutes the image data obtaining section 440, the set up section 350 constitutes the set up section 450, the image data with chart creating section 360 constitutes the image data with chart creating section 460, and the output section 370 constitutes the output section 470.

The memory 480 of the chart data creating apparatus 400 stores K-ink data D1 indicative of a predetermined use level for K-ink in the printer 60 also shown in FIG. 1, which outputs an image represented by image data with CMYK four colors. According to the present embodiment, the use level for K-ink is expressed at a ratio that white color is “0” percent, and black color is “100” percent. Likely, the use levels for CMY-inks are also expressed at a ratio of “0” percent to “100” percent. The K-ink data D1 indicates the use level of K-ink in “25” percent. The gray color, which is represented by the use level of K-ink in “25” percent, corresponds to the reference color referred to in the present invention.

The balance data obtaining section 410 obtains first balance data D2 representative of a balance of the use levels for inks of CMY three colors, where the gray color, which is represented by the use level of K-ink in “25” percent, is reproduced in the printer 60 with inks of CMY three colors. According to the present embodiment, the first balance data D2 represents the above-mentioned balance with the combination of the use levels for inks of CMY three colors at the ratio as mentioned above.

The balance data creating section 420 creates 6 sorts of data D3a to D3f, as set forth below, from the first balance data D2, as second balance data representative of a balance that is different from the balance of the use levels for inks of CMY three colors represented by the first balance data D2.

Specifically, the balance data creating section 420 creates 6 sorts of data D3a to D3f, that is, the second balance data D3a in which the use level of C-ink in the first balance data D2 is altered by “+5” percent, the second balance data D3b in which the use level of C-ink is altered by “−5” percent, the second balance data D3c in which the use level of M-ink is altered by “+5” percent, the second balance data D3d in which the use level of M-ink is altered by “−5” percent, the second balance data D3e in which the use level of Y-ink is altered by “+5” percent, and the second balance data D3f in which the use level of Y-ink is altered by “−5” percent.

The chart data creating section 430 creates chart data D4 representative of a color chart that is a first embodiment of a color chart of the present invention, which will be explained later, in accordance with the K-ink data D1, the first balance data D2, and the above-mentioned 6 sorts of second balance data D3a to D3f.

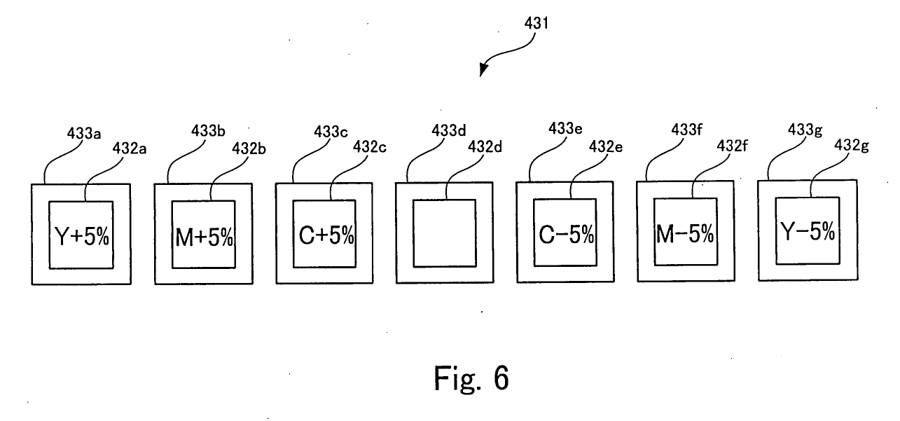

FIG. 6 is a typical illustration showing a first embodiment of a color chart of the present invention.

A color patch 431 shown in FIG. 6 comprises 7 inside patches 432a to 432g each having a square configuration, which are mutually different in color, and 7 outside patches 433a to 433g encircling the associated inside patches 432a to 432g, respectively, which are of the same color as one another.

A color of 7 outside patches 433a to 433g is a gray color, which is represented by the use level of K-ink in “25” percent according to K-ink data D1. Those 7 outside patches 433a to 433g correspond to an example of the reference patch in the color chart of the present invention.

Of those 7 inside patches 432a to 432g, the color of the inside patches 432d, which is located at the center, is the reproduction gray color, in which the gray color is reproduced with inks of CMY three colors, according to the first balance data D2. The inside patches 432d corresponds to an example of the first adjacent patch in the color chart of the present invention. In the event that the calibration work is applied to the printer 60 (cf. FIG. 1 and FIG. 5) that outputs the color chart 431 shown in FIG. 6 so that the printer 60 is maintained normally in its image forming characteristic, the gray color is substantially coincident with the reproduction gray color. Thus, in this case, the color of the inside patches 432d is substantially coincident with the color of the outside patch 433d encircling the inside patches 432d.

Of those 7 inside patches 432a to 432g, 6 inside patches 432a to 432c, and 432e to 432g, excepting the inside patch 432d, correspond to an example of the second adjacent patch in the color chart of the present invention. Three inside patches 432a to 432c, which are located at the left side with respect to the inside patch 432d of the center, are concerned, from the center, with the inside patch 432c having the color indicated by the second balance data D3a in which the use level of C-ink in the first balance data D2 is altered by “+5” percent, the inside patch 432b having the color indicated by the second balance data D3c in which the use level of M-ink is altered by “+5” percent, and the inside patch 432a having the color indicated by the second balance data D3e in which the use level of Y-ink is altered by “+5” percent. And three inside patches 432e to 432g, which are located at the right side with respect to the inside patch 432d of the center, are concerned, from the center, with the inside patch 432e having the color indicated by the second balance data D3b in which the use level of C-ink in the first balance data D2 is altered by “−5” percent, the inside patch 432f having the color indicated by the second balance data D3d in which the use level of M-ink is altered by “−5” percent, and the inside patch 432g having the color indicated by the second balance data D3f in which the use level of Y-ink is altered by “−5” percent. In the event that the printer 60 is normal in its image forming characteristic, the colors of 6 inside patches 432a to 432c, and 432e to 432g are not coincident with the gray color, as compared with the reproduction gray color. Thus, in this case, the colors of the inside patches are different from the colors of the outside patches encircling the inside patches.

In the printer 60, a change of the image forming characteristic due to a lapse of long time after the calibration work is applied would cause a balance of the use level of inks for CMYK in the printer 60 to deviate from the balance at the time of the calibration. And it is known from experience that the change of either one of the use levels of inks for CMYK brings about deviation of the balance. According to the present embodiment, the deviation of the balance causes the color of the center of inside patch 432d to be different from the color of the outside patch 433d encircling the center of inside patch 432d, and reversely the color of either inside patch of all the inside patches but the center of inside patch 432d is close to the color of the outside patch encircling the inside patch. According to the present embodiment, regarding the color chart 431, in the event that any one combination other than the combination of the center of inside patch 432d and the outside patch 433d is concerned with a combination closer in their associated colors than combination of the center of inside patch 432d and the outside patch 433d, it is decided that the printer 60 that outputs the color chart 431 needs the calibration work.

As mentioned above, according to the present embodiment, the color of the outside patch 433d is the gray color represented by the use level of K-ink in “25” percent. The reason why this is to do so is that it is known from experience that the gray color represented by the use level of K-ink in about “30” percent is relatively easy for a person to recognize the difference between the color of the inside patch and other color in comparison.

As mentioned above, according to the present embodiment, the chart data creating section 430 shown in FIG. 5 creates the chart data D4 representative of the color chart 431 shown in FIG. 6.

The explanation will be continued again referring to FIG. 5.

The image data obtaining section 440 of the chart data creating apparatus 400 shown in FIG. 5 obtains the image data D5 representative of the image outputted from the printer 60.

The set up section 450 receives data indicative of either one of two output schemes as set forth below in form of output scheme set up data D6 indicative of an output scheme where the printer 60 outputs the color chart 431 shown in FIG. 6. According to the present embodiment, it is possible to output the color chart 431 in accordance with either one of a first output scheme in which the color chart 431 is outputted on a sheet alone and a second output scheme in which the color chart 431 is outputted on a sheet together with an image. The output scheme is indicated by the output scheme set up data D6 that is to be fed to the set up section 450.

In the event that the output scheme indicated by the output scheme set up data D6 is concerned with the second output scheme, the image data with chart creating section 460 uses the chart data D4 and the image data D5 to create image data with chart D7 representative of an image with chart, in which the color chart 431 (cf. FIG. 6) represented by the chart data D4 is appended to the image represented by the image data D5.

The output section 470 outputs the chart data D4, the image data D5, and the image data with chart D7 to the printer 60 in accordance with the output scheme indicated by the output scheme set up data D6.

Upon receipt of the chart data D4 from the output section 470, the printer 60 outputs a chart image 62 wherein the color chart 431 is printed. Upon receipt of the image data D5 from the output section 470, the printer 60 outputs an image indicated by the image data D5 in form of a proof image 61. Upon receipt of the image data with chart D7 from the output section 470, the printer 60 outputs an image with chart 63 in form of a proof image.

A user of the printing-proof system shown in FIG. 1 visually confirms a color of the color chart 431 printed on the chart image 62 or the image with chart 63, and decides that the printer 60 needs the calibration work when any one combination other than the combination of the center of inside patch 432d and the outside patch 433d is concerned with a combination closer in their associated colors than combination of the center of inside patch 432d and the outside patch 433d. In the printing-proof system, a user of the printing machine 40, which receives the proof image 61 and the chart image 62, or the image with chart 63, can decide from the color of the color chart 431 whether those images are outputted from the printer 60 that is in the normal state.

Up to here, of the workstation 20 and the personal computer 50, which are operated as the embodiment of the chart data creating apparatus of the present invention, in the printing-proof system shown in FIG. 1, there is explained, as a typical example, the personal computer 50, which is operated as the embodiment of the chart data creating apparatus of the present invention. On the other hand, in the event that the workstation 20 operates as the embodiment of the chart data creating apparatus of the present invention, the state of the printing system from the film printer 30 to the printing machine 40 is judged from the color of the color chart 431 outputted from the printing machine 40.

As explained referring to FIG. 1 to FIG. 6, according to the chart data creating apparatus 400 of the present embodiment, it is possible to create the chart data representative of the color chart 431 capable of simply judging the execution time of the calibration work.

According to the above explanation, as the embodiment of the color chart of the present invention, there is raised the color chart 431 shown in FIG. 6. However, the color chart of the present invention is not restricted to this embodiment, and altered two embodiments of the color chart, which will be explained hereinafter, are acceptable for instance.

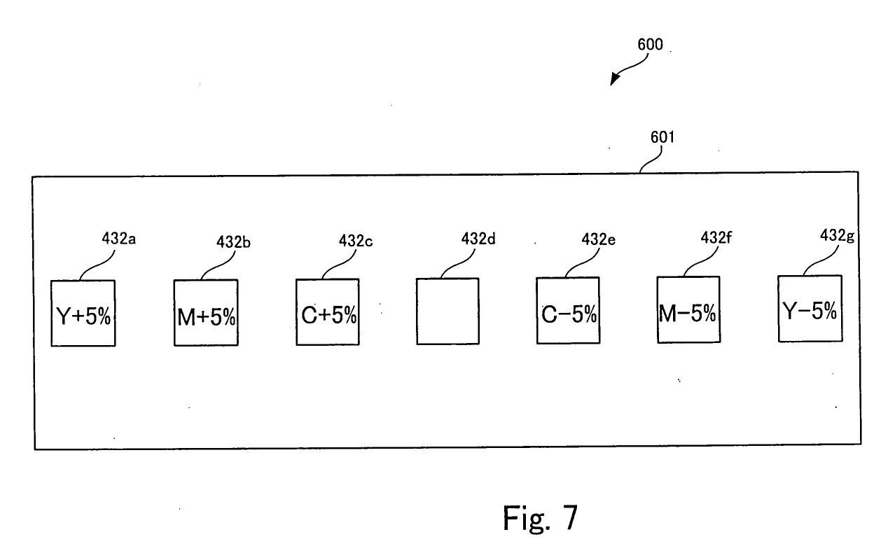

FIG. 7 is a typical illustration showing a second embodiment of a color chart of the present invention.

A color chart 600 shown in FIG. 7 has the same form as the color chart 431 shown in FIG. 6 except a point that 7 output patches 433a to 433g of the color chart 431 shown in FIG. 6 are replaced by only a background patch 601. Accordingly, in FIG. 7, the same parts are denoted by the same reference numbers as those of FIG. 6, and redundant explanation will be omitted.

In the color chart 600 shown in FIG. 7, the background patch 601 has a gray color expressed by the use level of K-ink in “25” percent. The background patch 601 corresponds to an example of the reference patch in the color chart of the present invention.

According to the color chart 600, in the event that any one of the inside patches other than the center of inside patch 432d is concerned with a patch closer in color to the background patch 601 than the center of inside patch 432d, it is decided that the image forming apparatus that outputs the color chart 600 needs the calibration work.

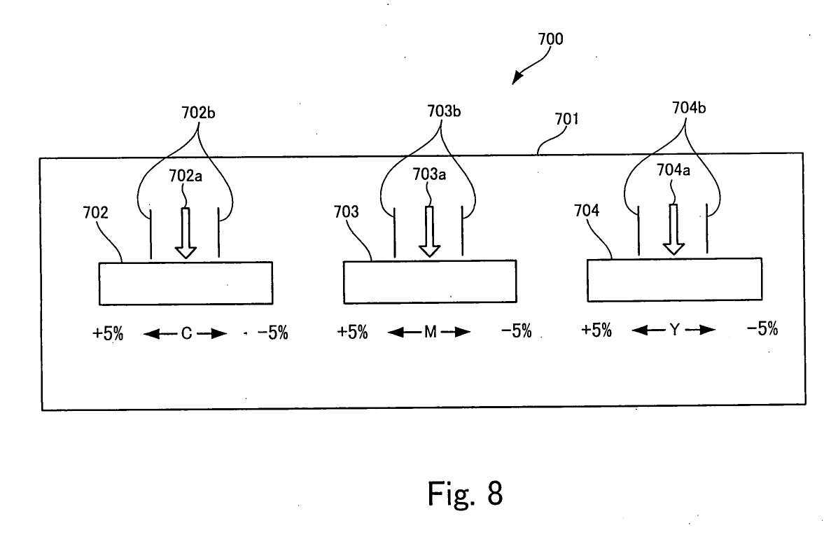

FIG. 8 is a typical illustration showing a third embodiment of a color chart of the present invention.

A color patch 700 shown in FIG. 8 comprises a background patch 701 and three gradation bars 702 to 704.

The background patch 701 has a gray color expressed by the use level of K-ink in “25” percent. The background patch 701 corresponds to an example of the reference patch in the color chart of the present invention.

Three gradation bars 702 to 704 are formed with CMY three colors of inks, and correspond to an example of the gradation bar in the color chart of the present invention.

Each of the gradation bars 702 to 704 is formed in such a manner that the color of the center portion is a reproduction color in which the gray color is reproduced with CMY three colors of inks. The gradation bar 702 of the left side is formed in such a manner that the use level of C-ink is gradually increased to “+5” percent with respect to the use level of C-ink in the center portion as the gradation bar 702 goes toward the left, and the use level of C-ink is gradually decreased to “−5” percent with respect to the use level of C-ink in the center portion as the gradation bar 702 goes toward the right. The gradation bar 703 of the center is formed in such a manner that the use level of M-ink is gradually increased to “+5” percent with respect to the use level of M-ink in the center portion as the gradation bar 703 goes toward the left, and the use level of M-ink is gradually decreased to “−5” percent with respect to the use level of M-ink in the center portion as the gradation bar 703 goes toward the right. The gradation bar 704 of the center is formed in such a manner that the use level of Y-ink is gradually increased to “+5” percent with respect to the use level of Y-ink in the center portion as the gradation bar 704 goes toward the left, and the use level of Y-ink is gradually decreased to “−5” percent with respect to the use level of Y-ink in the center portion as the gradation bar 704 goes toward the right. In the vicinity of the centers of the gradation bars 702, 703 and 704, there are added arrows 702a, 703a and 704a, which indicate the center of the associated gradation bar, and two-lines 702b, 703b and 704b, which indicate the specified tolerance.

According to the color chart 700, in the event that any one of the gradation bars 702, 703 and 704 is concerned with a gradation bar closer in color to the background patch 701 than the inside of the two-line indicating the specified tolerance, which gradation bar is located at the outside of the two-lines 702b, 703b and 704b, which indicate the specified tolerance, it is decided that the image forming apparatus that outputs the color chart 700 needs the calibration work.

As mentioned above, the use of two types of color charts 600 and 700 explained referring to FIG. 7 and FIG. 8 makes it possible to visually simply judge the execution time of the calibration work of the image forming apparatuses that output the color charts 600 and 700.

According to the above explanation, as an example of the reference color referred to in the present invention, there is raised the gray color represented by the use level of K-ink in “25” percent. However, the present invention is not restricted to this example. It is acceptable that the reference color referred to in the present invention is the gray color represented by the use level of K-ink in, for example, “30” percent and “50” percent other than “25” percent, or alternatively it is acceptable that the reference color referred to in the present invention is colors and the like represented by a plurality of inks including inks other than K-ink.

According to the above explanation, as an example of the geometry of the reference patch referred to in the present invention, the first adjacent patch, and the second adjacent patch, there are shown a square and a rectangle. However, the present invention is not restricted to this example. It is acceptable that the geometry of the patches is a circle and an ellipse, for example, or alternatively a polygon such as a triangle and a pentagon.

Further, according to the above explanation, as an example of the chart data creating apparatus of the present invention, there is raised the chart data creating apparatus incorporated into a workstation and a personal computer that input image data representative of an image to a printing system including a printing machine and a printer. However, the present invention is not restricted to this example. It is acceptable that the chart data creating apparatus of the present invention is an additional apparatus that is independent of the workstation and the personal computer.

As mentioned above, according to the present invention, it is possible to provide a color chart capable of simply deciding time of an execution for a calibration work, a chart data creating apparatus for creating chart data representative of the color chart, and a chart data creating program storage medium storing a chart data program which causes a computer to operate as the chart data creating apparatus when the chart data program is executed in the computer.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A color chart comprising:
at least one reference patch formed with at least one color material, the reference patch having a predetermined reference color;
a first adjacent patch adjacent to the reference patch, the first adjacent patch being formed in such a manner that the reference color is reproduced with a plurality of colors of color materials including a color material different from the color material of the reference patch; and
a second adjacent patch adjacent to the reference patch, the second adjacent patch being formed with same color material as the color materials of the first adjacent patch and use level of color material of a balance that is different from a balance of use level of the color material of the first adjacent patch.

2. A color chart according to claim 1, wherein the second adjacent patch is different in use level of one color material of the color materials from the use level of the color material of the first adjacent patch.

3. A color chart according to claim 1, wherein the color chart has a gradation bar serving both as the first adjacent patch and the second adjacent patch.

4. A color chart according to claim 1, wherein the color chart has, as the reference patch, a plurality of reference patches corresponding to the first adjacent patch and the second adjacent patch on a one-to-one basis.

5. A color chart according to claim 1, wherein the color chart has, as the reference patch, only one reference patch adjacent to both the first adjacent patch and the second adjacent patch.

6. A chart data creating apparatus comprising:
a balance data obtaining section that obtains first balance data representative of a balance of use level of a color material where an image forming apparatus for outputting an image represented by image data with a plurality of color materials is used to reproduce a predetermined reference color, which is represented with at least one color material by the image forming apparatus, with a plurality of colors of color materials including a color material different from said color material;
a balance data creating section that creates a second balance data through alteration of the balance of the use level represented by the first balance data; and
a chart data creating section that creates chart data representative of a color chart in accordance with the first balance data and the second balance data, the color chart comprising: at least one reference patch having the reference color; a first adjacent patch adjacent to the reference patch, the first adjacent patch being formed in such a manner that the reference color is reproduced with a plurality of colors of color materials including a color material different from the color material of the reference patch; and a second adjacent patch adjacent to the reference patch, the second adjacent patch being formed with same color material as the color materials of the first adjacent patch and use level of color material of a balance that is different from a balance of use level of the color material of the first adjacent patch.

7. A chart data creating apparatus according to claim 6, wherein the chart data creating apparatus further comprises:
an image data obtaining section that obtains image data; and
an image data with chart creating section that creates image data with chart representative of an image with chart in which a color chart represented by the chart data is appended to an image represented by the image data, using the chart data created by the chart data creating section and the image data.

8. A chart data creating program storage medium storing a chart data creating program which causes a computer to operate as a chart data creating apparatus, when the chart data creating program is incorporated into the computer and is executed, the chart data creating apparatus comprising:
a balance data obtaining section that obtains first balance data representative of a balance of use level of a color material where an image forming apparatus for outputting an image represented by image data with a plurality of color materials is used to reproduce a predetermined reference color, which is represented with at least one color material by the image forming apparatus, with a plurality of colors of color materials including a color material different from said color material;
a balance data creating section that creates a second balance data through alteration of the balance of the use level represented by the first balance data; and
a chart data creating section that creates chart data representative of a color chart in accordance with the first balance data and the second balance data, the color chart comprising: at least one reference patch having the reference color; a first adjacent patch adjacent to the reference patch, the first adjacent patch being formed in such a manner that the reference color is reproduced with a plurality of colors of color materials including a color material different from the color material of the reference patch; and a second adjacent patch adjacent to the reference patch, the second adjacent patch being formed with same color material as the color materials of the first adjacent patch and use level of color material of a balance that is different from a balance of use level of the color material of the first adjacent patch.
